(19) United States
(12) Patent Application Publication
(10) Pub. No.: US 2026/0308354 A1
(43) Pub. Date: Oct. 8, 2026

(54) Composition for Use in the Sulphur Based Vulcanization of Rubber

(71) Applicant: Rubber Nano Products (Proprietary) Limited, Gqeberha (ZA)

(72) Inventor: Robert Michael Bosch, Gqeberha (ZA)

(21) Appl. No.: 19/119,529

(22) PCT Filed: Oct. 10, 2023
(86) PCT No.: PCT/IB2023/060160

§ 371 Date: Apr. 9, 2025

(30) Foreign Application Priority Data
Oct. 10, 2022 (ZA) 2022/11016

(51) Int. Cl. C08K 3/34; C08K 3/04; C08K 3/06; C08K 3/22; C08K 3/26; C08K 3/38; C08K 5/12; C08K 5/205; C08K 5/44; C08K 5/47; C08L 9/06

(52) U.S. Cl. CPC C08K 3/34; C08K 3/04; C08K 3/06; C08K 3/22; C08K 3/26; C08K 3/38; C08K 5/12; C08K 5/205; C08K 5/44; C08K 5/47; C08L 9/06; C08K 2003/2206; C08K 2003/2227; C08K 2003/265; C08K 2003/387; C08K 2201/019; C08L 2207/322

(57) ABSTRACT

Provided is a vulcanization composition which is suitable for use in a sulphur based vulcanization process. The composition is a non-aqueous water soluble polymer based composition including a cationic silicate component, a cationic additive, a borate compound, and a hydroxyl containing aluminium compound. Also provided are a method for vulcanizing a rubber masterbatch, and a rubber product produced by such a method.

### CROSS-REFERENCE TO RELATED APPLICATIONS

This application is the United States national phase of International Patent Application No. PCT/IB2023/060160 filed Oct. 10, 2023, and claims priority to South African Patent Application No. 2022/11016 filed Oct. 10, 2022, the disclosures of which are hereby incorporated by reference in their entireties.

### BACKGROUND OF THE INVENTION

This invention relates to a composition which is suitable for use in the sulphur based vulcanization of the rubber, and also to the use of the composition in the vulcanization of rubber. The composition is a non-aqueous water soluble polymer based composition comprising a borate compound a hydroxyl containing aluminium species.

### FIELD OF THE INVENTION

It is well known in the art of rubber formulation and rubber vulcanization that activators and accelerators play an important part in the vulcanization process, including in sulphur based vulcanization processes. Together with the other components in the specific cure package, the activator and accelerator determine, to a large extent, the reaction kinetics of the vulcanization process.

### DESCRIPTION OF RELATED ART

The specific activator (typically inorganic oxides) and accelerator, or blend of these compounds, used in the vulcanization of a rubber masterbatch is also key in determining the properties of the final rubber product produced by the process. This is so because interaction among these species is responsible for the formation of intermediate metal complexes, which are able to increase the reactivity of sulphur towards the polymer and to promote the chemical cross-links between the rubber chains in the final product.

In this process, ZnO is generally considered the most efficient activator. Zinc complexes that form in the process are known to be central in determining both the reaction kinetics and the nature of the vulcanized products. However, ZnO has been recognised as a significant ecotoxin, especially in aquatic environments. Accordingly, a great deal of effort has gone into the development of methods and systems to reduce the zinc content in rubber products. Some of the attention has been focused on alternative inorganic oxides, although many of these substitutes will be equally environmentally undesirable. Despite the issue receiving considerable attention, a zinc-free sulphur based vulcanisation system remains elusive.

The applicant's own WO 2019/145808 describes that a cationic silicate component in a water soluble polymer has unexpected vulcanization performance in terms of cure rate and rubber properties in the manufacture of rubber. It has further been found that the cationic silicate/polymer composition acts as a carrier system for the incorporation of further cationic materials, for example accelerator salt complexes or nanopowders, with these systems providing unexpected, synergistic effects in the vulcanization of rubber. The disclosure of WO 2019/145808 is incorporated herein in its entirety by reference.

The inventor has now surprisingly found that the addition of a borate compound and a hydroxyl containing aluminium species, dissolved in the cationic silicate/polymer/cationic additive composition of WO 2019/145808, allows for the zinc free vulcanization of rubber.

### SUMMARY OF THE INVENTION

According to a first aspect to the present invention there is provided a rubber vulcanization composition suitable for use in a sulphur based vulcanization process, the composition comprising:
a) a water soluble polymer, a cationic silicate component, and a cationic additive component,
b) a borate compound, and
c) a hydroxyl containing aluminium compound.

In one embodiment, the hydroxyl containing aluminium compound is aluminium trihydrate.

In a preferred embodiment, the composition does not include an inorganic oxide including zinc oxide.

In one embodiment, the borate compound is a salt of a boron oxyanion selected from the group consisting of orthoborates, metaborates, and tetraborates.

In one embodiment, the borate compound is selected from the group consisting of calcium borate, zinc borate, magnesium borate, sodium borate, and potassium borate.

Preferably, the cationic additive component is a salt of a vulcanization accelerator.

The vulcanization accelerator may preferably selected from a group of accelerator classes including thiazoles, dithiocarbamates, dithiophosphates, sulfenamides, thiuram sulfides, xanthates, guanidines, aldehyde amines, or combinations thereof.

In some embodiments, the vulcanization accelerator is selected from a group of accelerator classes including thiazoles, dithiocarbamates, dithiophosphates, thiuram sulphides, or combinations thereof.

In some embodiments, the salt of the vulcanization accelerator is a salt of 2-mercaptobezothiazole (MBT), zinc dibenzyldithiocarbamate (ZBEC), sodium dibenzyldithiocarbamate (NaBEC), zinc dialkyldithiophosphate (ZBOP), tetrabenzyl thiuramdisulfide (TBzTD), Di-isopropyl xanthogen disulphide (DIXD) or polysulfide (AS100), or combinations thereof.

Preferably, the salt of the vulcanization accelerator is a sodium or potassium salt thereof.

Preferably, the cation of the cationic silicate component is a sodium or potassium cation.

In preferred embodiments, the water soluble polymer is an ethylene oxide polymer or polyvinyl alcohol polymer.

In a particularly preferred embodiment, the water soluble polymer is polyethylene glycol.

In some embodiments, the water soluble polymer has a molecular weight of between 300 g/mol and 10,000,000 g/mol, preferably between 500 and 20,000 g/mol, more preferably between about 1,000 and 10,000 g/mol.

In a preferred embodiment, the water soluble polymer, cationic silicate component, and cationic additive component forms an ionic liquid composition.

In one embodiment, the ionic liquid composition comprises polyethylene glycol, sodium metasilicate and accelerator salt NaBEC.

In one embodiment, the water soluble polymer, cationic silicate component, and cationic additive component is suspended in a thermoplastic elastomer.

In one embodiment, the composition further comprises a silicate compound.

Preferably, the borate compound and the hydroxyl containing aluminium compound is dissolved in the ionic liquid.

According to a second aspect to the present invention there is provided a method for the sulphur based vulcanization of a rubber masterbatch, the method comprising the steps of:
a) providing a rubber masterbatch to be vulcanized, and
b) mixing the rubber masterbatch with a vulcanization composition comprising a water soluble polymer, a cationic silicate component, a cationic additive component, a borate compound, and a hydroxyl containing aluminium compound to prepare a rubber containing reaction mixture.

The sulphur may be provided in the rubber masterbatch, premixed into the vulcanization composition of step (b), or provided separately in an additional processing step.

In one embodiment, the rate of cure is controlled by the addition of a metal oxide having the same metal species as the borate compound.

In one embodiment, the hydroxyl containing aluminium compound is aluminium trihydrate.

In one embodiment, the method does not include the use of an inorganic oxide including zinc oxide.

In some embodiments, the borate compound is a salt of a boron oxyanion selected from the group consisting of orthoborates, metaborates, and tetraborates.

In some embodiments, the borate compound is selected from the group consisting of calcium borate, zinc borate, magnesium borate, sodium borate, and potassium borate.

In one embodiment, the cationic additive component is a salt of a vulcanization accelerator.

Preferably, the vulcanization accelerator is selected from a group of accelerator classes including thiazoles, dithiocarbamates, dithiophosphates, sulfenamides, thiuram sulfides, xanthates, guanidines, aldehyde amines, or combinations thereof.

Preferably, the vulcanization accelerator is selected from a group of accelerator classes including thiazoles, dithiocarbamates, dithiophosphates, thiuram sulphides, or combinations thereof.

In some embodiments, the salt of the vulcanization accelerator is a salt of 2-mercaptobezothiazole (MBT), zinc dibenzyldithiocarbamate (ZBEC), sodium dibenzyldithiocarbamate (NaBEC), zinc dialkyldithiophosphate (ZBOP), tetrabenzyl thiuramdisulfide (TBzTD), Di-isopropyl xanthogen disulphide (DIXD) or polysulfide (AS100), or combinations thereof.

In some embodiments, the salt of the vulcanization accelerator is a sodium or potassium salt thereof.

Preferably, the cation of the cationic silicate component is a sodium or potassium cation.

In some embodiments, the water soluble polymer is an ethylene oxide polymer or polyvinyl alcohol polymer.

In one embodiment, the water soluble polymer is polyethylene glycol.

In some embodiments, the water soluble polymer has a molecular weight of between 300 g/mol and 10,000,000 g/mol, preferably between 500 and 20,000 g/mol, more preferably between about 1,000 and 10,000 g/mol.

Preferably, the water soluble polymer, cationic silicate component, and cationic additive component forms an ionic liquid composition.

In one embodiment, the ionic liquid composition comprises polyethylene glycol, sodium metasilicate and accelerator salt NaBEC.

In one embodiment, the water soluble polymer, cationic silicate component, and the cationic additive component is suspended in a thermoplastic elastomer.

In one embodiment, the vulcanization composition further comprises a silicate compound.

In one embodiment, the borate compound and the hydroxyl containing aluminium compound is dissolved in the ionic liquid.

According to another aspect to the present invention there is provided a rubber product produced by the method of the present invention.

In a preferred embodiment, the rubber product does not include any zinc or source of zinc.

### BRIEF DESCRIPTION OF THE DRAWINGS

The terms Fig., Figs., Figure, and Figures are used interchangeably in the specification to refer to the corresponding figures in the drawings.

The invention will now be described in more detail with reference to the following non-limiting embodiments and figures in which:

FIG. 1 shows the cure response for the vulcanization of a standard SBR masterbatch with different ratios of calcium borate and aluminium trihydrate;

FIG. 2 shows the effect of an increase in sulphur content in a standard SBR masterbatch in vulcanization with a composition comprising calcium borate and aluminium trihydrate in NaBEC-NaSil-PEG (“Activ8™”);

FIG. 3 shows the effect on total cure and cure rate by the addition of Ca(OH)₂ in a calcium borate containing system; and

FIG. 4 shows the cure response at 180° C. for the vulcanization of a NBR masterbatch with ZnO based vulcanization (A) system compared to a ZnO free system (P) utilising calcium borate and aluminium trihydrate in Activ8™;

FIG. 5 shows total cure and rate of cure traces for a ZnO based NBR vulcanizate at 0.8 (A) and 2.8 (D) pphr of sulphur respectively;

FIG. 6 shows total cure and rate of cure traces for a ZnO free NBR vulcanizate at 0.8 (C) and 2.8 (F) pphr of sulphur respectively;

FIG. 7 shows total cure and rate of cure traces for reversion matching experiments with a ZnO based NBR vulcanizate (G) and a ZnO free NBR vulcanizate (H) respectively;

FIG. 8 shows rate of cure traces for a ZnO free NBR vulcanizate (J), optimized to match a ZnO based NBR vulcanizate (A);

FIG. 9 shows modulus and tensile strength comparison for the ZnO free NBR vulcanizate (J) and the ZnO based NBR vulcanizate (A); and

FIG. 10 shows modulus and tensile strength comparison for the ZnO free NBR vulcanizate (J) and the ZnO based NBR vulcanizate (A) after thermal aging.

### DESCRIPTION OF THE INVENTION

The present invention will now be described more fully hereinafter with reference to the accompanying figures, in which some of the non-limiting embodiments of the invention are shown.

The invention as described hereinafter should not be construed to be limited to the specific embodiments disclosed, with slight modifications and other embodiments intended to be included within the scope of the invention.

Although specific terms are employed herein, they are used in a generic and descriptive sense only and not for purposes of limitation.

As used herein, throughout this specification and in the claims which follow, the singular forms “a”, “an” and “the” include the plural form, unless the context clearly indicates otherwise.

The terminology and phraseology used herein is for the purpose of description and should not be regarded as limiting. The use of the terms “comprising”, “containing”, “having”, “including”, and variations thereof used herein, are meant to encompass the items listed thereafter, and equivalents thereof as well as additional items.

As used in this specification, the term “water soluble polymer” should be understood to mean a polymer that dissolves, disperses, or swells in water including polymers comprising hydroxyl groups, for example an ethylene oxide type polymer or a polyvinyl alcohol polymer.

The present invention provides for a rubber vulcanization composition that it suitable for use in sulphur based vulcanization processes. The vulcanization composition includes a water soluble polymer based composition comprising a cationic silicate component and a second cationic component which is referred to hereinafter as a cationic additive component, which is dissolved in and stabilised by the cationic silicate-polymer composition. The vulcanization composition further comprises a borate compound and a hydroxyl containing aluminium compound, which compounds are similarly dissolved in and stabilised by the cationic silicate-polymer composition.

These vulcanization compositions have shown surprising and unexpected results in the sulphur based vulcanization of various rubber systems, including processes for the vulcanization of rubber systems without the need for the use or addition of any inorganic oxide activators, including zinc oxide. However, it has also been observed that the vulcanization compositions of the invention has potential in systems utilising zinc oxide, thereby producing rubber with surprising properties including modulus.

The hydroxyl containing aluminium compound may be any aluminium compound including one or more hydroxyl groups. Without thereby wishing to be bound by any particular theory, it is envisaged that the Al and OH ions are integral to the reaction chemistry taking place in the vulcanization process, in particular to stabilise the reactants and to make sulphur available for cross-linking reactions. In one example, the hydroxyl containing aluminium compound is aluminium trihydrate, Al(OH)₃, otherwise known as aluminium hydroxide.

The borate compound may be any borate species that is a suitable source of boron oxyanions, including salts of boron oxyanions selected from orthoborates, metaborates, and tetraborates. For example, depending on the other reagents in the composition and the overall reaction scheme, the borate compound may be selected from any suitable boron oxyanion source including calcium borate, zinc borate, magnesium borate, sodium borate, and potassium borate. For applications where no zinc is desirable, such as in rubber for the tyre and carpet industries, the boron oxyanion source can be selected from calcium borate, magnesium borate, sodium borate, and potassium borate.

The second cationic component, or cationic additive component, may be any known cationic material used in the vulcanization of rubber, for example a metal salt of metal oxide, such as zinc oxide, the cationic salt of a known vulcanization accelerator, or cationic nanopowders, such as reduced graphene oxide. As discussed in relation to the boron compound, for zero zinc applications the cationic additive component may be selected from other compounds, for example cationic salts of known vulcanization accelerator not including zinc.

Depending on the particular application and the nature of the rubber masterbatch to be vulcanized, the salt of the vulcanization accelerator may be selected from a group of accelerator classes including thiazoles, dithiocarbamates, dithiophosphates, sulfenamides, thiuram sulfides, xanthates, guanidines, aldehyde amines, or combinations thereof.

The composition according to the present invention provides for a non-aqueous polymer based composite material that results in either an oil or frozen wax material that is suitable for direct addition to rubber-like materials in normal mixing equipment in a standard rubber manufacturing environment. The polymer is a water soluble polymer, for example an ethylene oxide type polymer, a polyvinyl alcohol polymer, or any other polymer comprising hydroxyl groups. Therefore, the composition according to the present invention, allows for the dosing of essentially caustic polar accelerator salt materials in an easy and safe manner.

The invention may now be further described with reference to the main steps of preparing the water soluble polymer based vulcanization composition. A suitable cationic silicate component solution is synthesized by dissolving silica powder in a basic solution, for example sodium hydroxide or potassium hydroxide. The resultant cationic silicate component may be added to a water soluble polymer, for example an ethylene oxide polymer including polyethylene glycol, and dried to produce a stable ionic solution or ionic liquid of the particular cationic silicate component.

The particular combination of the cation silicate component and the polymer, for example polyethylene glycol, as a replacement for the aqueous environment, allows for a suitably stable ionic solution. This allows for greater reaction capability and potential as a reactive solvent media and stabiliser for further cationic additive components and other ionic compounds that may be desirable in the rubber formulations to which it may be added, or that may be desirable in the vulcanization process as such. In the vulcanization compositions of the present invention, the dissolution and stabilisation of the boron and aluminium hydroxyl species play a critical part in the reaction chemistry towards a vulcanization process that can proceed in the absence of any inorganic oxide activator, including zinc oxide.

These cationic silicate solutions and the resultant cationic-silicate polymer compositions or complexes can be prepared by reacting different ratios of the selected cation to silica, thereby to modify the surface chemistry and the ionic nature of the solution and the resultant compositions. In one example, a stoichiometric ratio of cation to silica may be used. Alternatively, this ratio may be varied depending on the requirements of the particular vulcanization system. The cationic silicate-polymer carrier composition has been shown to be suitable for the dissolution and stabilisation of several ionic materials that may be known to be useful or beneficial in the vulcanization of rubber, for example various salts or nanopowders, such as graphene oxide or zinc oxide, or any other ionic material that may dissolved in or dispersed in the cationic silicate-polymer composition, being for example a non-aqueous sodium silicate or potassium silicate in polyethylene glycol. It has now also been found that these systems allow for the dissolution and stabilisation of boron compounds and hydroxyl containing aluminium species thereby providing a vulcanization composition that produces surprising vulcanization results in terms of cure, rate of cure and properties of the rubber produced, including a process and a rubber product not including any inorganic oxide activator, such as zinc oxide, where required.

The cationic silicate component may be prepared in water, or in a suitable azeotrope of water and alcohol, preferably water and isopropyl alcohol.

The vulcanization composition further comprises, as the cationic additive component, a salt of a vulcanization accelerator dissolved in the cationic silicate component and polymer carrier. The accelerator salt complex may be prepared in a caustic aqueous solution, for example a solution of sodium hydroxide or potassium hydroxide. The accelerator salt complex may be prepared by dissolving sodium hydroxide or potassium hydroxide in water before reaction with the accelerator fragment.

The accelerator salt complex may also be prepared in a suitable azeotrope of water and alcohol. In a preferred method of the present invention, the accelerator salt complex is prepared in a water isopropyl alcohol azeotrope mixture.

The accelerator component may be selected from any one of the accelerators known in the art, in particular the accelerator may be selected from a group of accelerator classes including thiazoles, dithiocarbamates, dithiophosphates, sulfenamides, thiuram sulfides, xanthates, guanidines, aldehyde amines, or combinations thereof.

In one example, the accelerator may selected from a group of accelerator classes including thiazoles, dithiocarbamates, dithiophosphates, thiuram sulphides, or combinations thereof. Preferably, the salt of a vulcanization accelerator is a sodium or potassium salt of 2-mercaptobezothiazole (MBT), zinc dibenzyldithiocarbamate (ZBEC), sodium dibenzyldithiocarbamate (NaBEC), zinc dialkyldithiophosphate (ZBOP), tetrabenzyl thiuramdisulfide (TBzTD), Di-isopropyl xanthogen disulphide (DIXD) or polysulfide (AS100), or combinations thereof.

The accelerator salt solution and solutions of the boron compound and the aluminium hydroxyl species are added to the cationic silicate solution to prepare a reaction mixture to which the water based polymer is added. The resultant reaction mixture is then dried to remove the solution medium, in particular to remove any water from the system. In one embodiment, the mixture may be dried under vacuum, for example at 100 mBar or less, to remove the solution medium. The resultant composition is a non-aqueous composition which is based on the water soluble polymer, for example polyethylene glycol. This non-aqueous composition is suitable for simple direct addition to solid, nonpolar rubber systems. The composition comprises a single phase with no layers of separation (organic or aqueous).

In one embodiment, the combination of the second cationic additive component, for example the accelerator salt complex, and the cationic silicate component may be selected so that the cation portion of the additive component and silicate component of the composition are the same, although different combinations may also be selected.

The cationic additive component and the cationic silicate component may comprise about 50% of the total mass of the polymer based composition, with the water based polymer component making up the rest of the composition.

In some embodiments of the invention, it may be beneficial for ease of product processing for the vulcanization composition to be suspended in a thermoplastic elastomer. The thermoplastic elastomer may be any elastomer with a melting point in the region of about 50° C. to about 100° C. Preferably, the thermoplastic elastomer does not contain any diene unsaturation. Preferably, the thermoplastic elastomer is selected from the group consisting of polyolefinic elastomers and have suitable softening and hardness points to allow for easier coating and blending in the required mixing conditions during the coating process. Furthermore, the thermoplastic elastomer should also have sufficient thermal stability to not degrade near any of the working temperatures of the vulcanization and post processing conditions of the final rubber composition.

Preferably, the thermoplastic elastomer is present at a concentration of about 10 to about 60 wt. %, more preferably about 15 to about 55 wt. %, more preferably about 15 to about 50 wt. %, even more preferably about 15 to about 45 wt. %, and most preferably about 20 to about 40 wt. %, by weight of the vulcanization composition.

Without thereby wishing to be bound to any particular theory, it is postulated that the solubility and the stabilisation of the hydroxyl containing aluminium compound and the borate compound in the water based polymer/cationic silicate/cationic additive solution is key to the chemistry involved in the vulcanization. It is envisaged that, in the first reaction, sulphur and a cation (Na⁺ in the example shown) interacts to form a cation sulphide species:

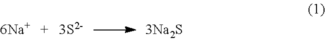

In a second reaction, it is envisaged that a reaction of the hydroxyl containing aluminium species (aluminium trihydrate in the example shown) interacts with the cation sulphide species to form NaOH:

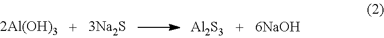

Following these reactions, it is envisaged that the aluminium and borate species interact:

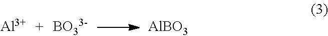

The system allows for the regeneration of species and the cyclical use of Na₂S.

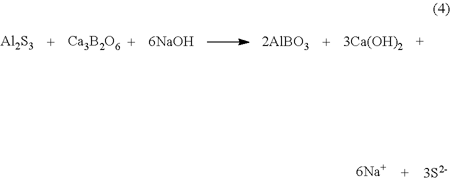

As has been described above, the role of calcium can be replaced with any suitable cationic species including, for example, magnesium, potassium, zinc, and others. Further, it will be appreciated that the rate of the reaction can be reduced, for example, by the addition of calcium hydroxide where calcium borate is the borate compound used in the vulcanization composition.

The invention will now be described in more detail with reference to the following, non-limiting, examples and experimental results. In the illustrative embodiments which follow the vulcanization composition has been based on polyethylene glycol, sodium metasilicate, and NaBEC. Those of ordinary skill in the art will appreciate that various other combinations of the essential features of the invention can be made and tested through routine experimentation, and that there would be a reasonable expectation of success based on the present disclosure.

### Example 1: Preparation of Sodium Silicate/Polyethylene Glycol/NaBEC Complex with Calcium Borate and Aluminium Trihydrate

In a suitable vessel 10 g of NaOH was added into 40 ml of water. To this solution, 7.5 g of silica powder was added while stirring. The solution was heated to 60° C. and the dissolution was seen to be rapid (the reaction is exothermic so not much heating is required). The solution was stirred for 5 minutes at 60° C. This solution is clear once the reaction of NaOH and SiO₂ is completed.

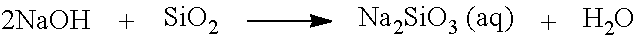

The sodium silicate solution can also be prepared in a suitable azeotrope, for example a water and isopropyl alcohol mixture.

15 g of polyethylene glycol was added to this solution where the amount of PEG is normally the same mass as the silicate content. The solution was stirred for 5 minutes at 60° C. until all the PEG is dissolved in the solution. The solution was dried at 105° C., at less than 100 mBar resulting in an amber clear sodium silicate-PEG composition.

In the examples which follow the mixture of sodium silicate/polyethylene glycol/NaBEC is referred to as “Activ8™”, while “PxActiv8™” refers to the sodium silicate/polyethylene glycol/NaBEC composition suspended in a thermoplastic elastomer (“TPE”). The viscosity of the TPE/Activ8™ blend is typically modified through the addition of silica which acts as a filler and aids in material handling.

The Activ8™ mixture was blended in an extruder (dual screw counter rotating) at a temperature above the softening point of the TPE carrier material. This is in the range of 60 to 100 degrees. Calcium borate powder and aluminium trihydrate powder was blended with the ionic liquid material (in its TPE encapsulated form) and the resultant material is then a TPE bound composition which is added in this form to standard rubber mixing. The ratios of this blending may be modified according to the rubber formulation and the particular vulcanization chemistry of the rubber type and cure package that is being used.

### Example 2: Vulcanization of a SBR Rubber Masterbatch

A standard SBR masterbatch as shown in Table 1 below was vulcanized with different ratios of calcium borate (Ca₃(BO₃)₂) and aluminium trihydrate (Al(OH)₃ or “ATH” in Table 2 below) in a composition comprising sodium silicate/polyethylene glycol/NaBEC (“Activ8™”) at 1 pphr.

TABLE 1
SBR masterbatch formulation with amounts indicated in pphr.

| Component | |
|---|---|
| 6PPD | 2.2 |
| Microwax | 2 |
| Stearic Acid | 1 |
| N330 | 27 |
| TDAE oil | 8 |
| SBR 1500 | 100 |
| N220 | 30 |

TABLE 2
Mixing formulary to consider effects of
Ca₃(BO₃)₂ and Al(OH)₃ concentration.

| Rubber | G (2732)^{#} | H (2733)^{#} | I (2734)^{#} |
|---|---|---|---|
| SBR MB | 170.2 | 170.2 | 170.2 |
| CBS | 1.2 | 1.2 | 1.2 |
| S8 | 1.6 | 1.6 | 1.6 |
| Activ8 ™ | 1 | 1 | 1 |
| Ca borate | 1 | 3 | 2 |
| ATH | 1 | 3 | 2 |

^{#}amounts in pphr

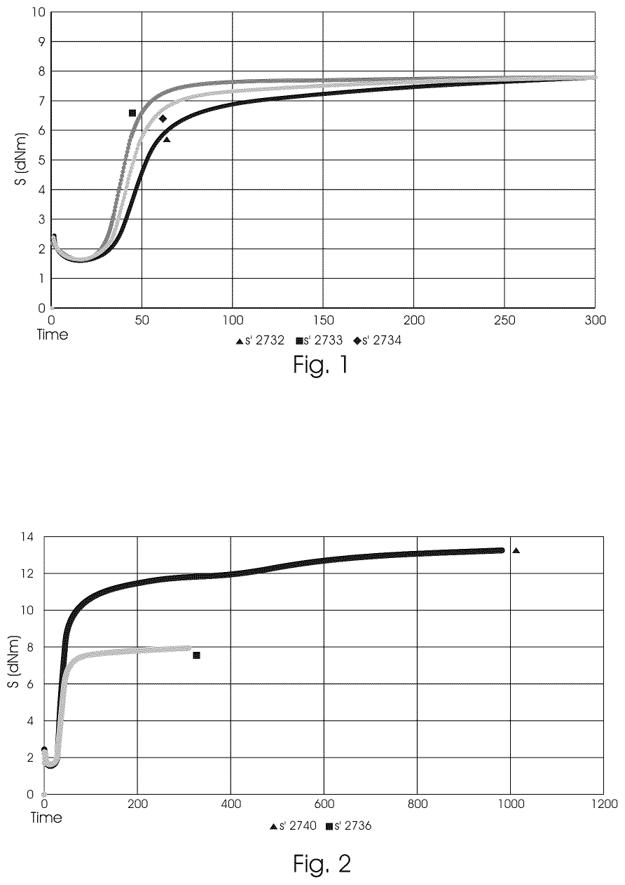

As can be seen from FIG. 1, the ratio and relative concentration of the borate compound and the aluminium hydroxyl species in Activ8™ had a definite impact on the rate of cure. Rheometry was done at 180° C. for faster testing times.

### Example 3: Effect of Sulphur Concentration on Vulcanization of a SBR Masterbatch

To evaluate and show the effect of an increase in sulphur content, the standard SBR masterbatch shown in Table 1 was vulcanized with different concentrations of sulphur with a vulcanization composition comprising calcium borate (1 pphr) and ATH (10 pphr) in Activ8™ (2 pphr).

TABLE 3
Mixing formulary to consider the effect of sulphur concentration.

| Rubber | K (2736) ^{#} | O (2740) ^{#} |
|---|---|---|
| SBR MB | 170.2 | 170.2 |
| CBS | 1.2 | 1.2 |
| S8 | 1.6 | 2.6 |
| Activ8 ™ | 2 | 2 |
| Ca borate | 1 | 1 |
| ATH | 10 | 10 |

^{#} amounts in pphr

The results of the vulcanization of samples 2736 (1.6 pphr S8) and 2740 (2.6 pphr S8) are shown in FIG. 2. It is clear from FIG. 2, that the concentration of elemental sulphur impacts on the curing of the reaction, with the amount of elemental sulphur available impacting on the formation and availability of the NA₂S species, as shown in reaction (1) above.

### Example 4: The Effect of the Addition of Ca(OH)₂

As the rate of cure of these reactions are extremely high, the effect of the addition of a species that would counteract the specific borate species used was investigated. In these examples, as calcium borate was used, the possible effect of the addition of Ca(OH)₂ to the vulcanization reaction was tested.

TABLE 4
Mixing formulary to consider the effect of
Ca(OH)₂ in a reaction with calcium borate.

| Rubber | I (2734) ^{#} | N (2739) ^{#} |
|---|---|---|
| SBR MB | 170.2 | 170.2 |
| CBS | 1.2 | 1.2 |
| S8 | 1.6 | 1.6 |
| Activ8 ™ | 1 | 2 |
| Ca borate | 2 | 2 |
| ATH | 2 | 2 |
| Ca(OH)₂ | | 2 |

^{#} amounts in pphr

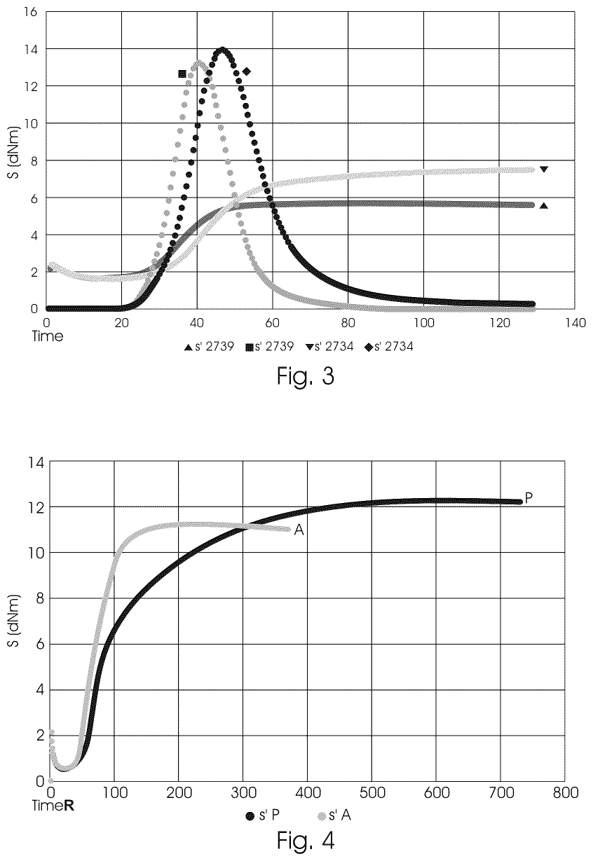

As can be seen from the results shown in FIG. 3, and with reference to equation (4) above, it is clear that the addition of calcium hydroxide to a vulcanization reaction using calcium borate will slow down the rate of cure as well as affect the final modulus of the vulcanizate.

### Example 5: Vulcanization of a NBR Masterbatch-ZnO and ZnO Free Reactions

A standard carpet backing type NBR masterbatch was vulcanized using a standard vulcanization package including ZnO, and compared to vulcanization of the same masterbatch using calcium borate (1 pphr) and aluminium trihydrate (ATH, 5 pphr) in a composition comprising sodium silicate/polyethylene glycol/NaBEC (3 pphr) suspended in a thermoplastic elastomer (“PxActiv8™”). In Table 5 below, the comparative ZnO mediated vulcanization is indicated as “A” while the vulcanization reaction according to the present invention is shown as “P”.

TABLE 5
Masterbatch and cure system formulary - ZnO and ZnO free.

| NBR masterbatch | A^{#} (ZnO) | P^{#} (ZnO free) |
|---|---|---|
| NBR polymer | 100 | 100 |
| Carbon black (SRF/GPF blend) | 75 | 75 |
| Plasticer DOTP | 32 | 32 |
| Calcium Carbonate | 10 | 10 |
| Stearic Acid | 1 | 1 |
| Antidegradant 1010 | 0.5 | 0.5 |
| Tackifying Resin | 5 | 5 |
| Struktol A50P | 1 | 1 |
| Cure System | | |
| Active Zinc Oxide (40 m2) | 2.5 | 0 |
| CBS 100% | 2.6 | 1.5 |
| TBBS 100% | 0 | 1.5 |
| MBT 80% | 0.2 | 0.2 |
| TBzTD 80% | 1.7 | 1.3 |
| Sulphur 80% | 1 | 2.4 |
| PxActiv8 ™ | 0 | 3 |
| Ca borate | 0 | 1 |
| ATH | 0 | 5 |

^{#}amounts in pphr

The results of the vulcanization of the systems in A and P shown in Table 5 above is indication in FIG. 4. As can be seen from FIG. 4, a NBR masterbatch which is typically used as a formulation for carpet backing material, was successfully vulcanized without ZnO.

### Example 6: Optimization of the Vulcanization of a NBR Masterbatch

In the experiments which follow, ZnO based vulcanization reactions and ZnO free vulcanization reactions were performed to match reversion and cure performance of the two systems. The NBR masterbatch and cure package components are shown in Table 6 below.

TABLE 6
Masterbatch and cure system formulary-ZnO and ZnO free optimization reactions.

| NBR masterbatch | A^{#} | D^{#} | C^{#} | F^{#} | G^{#} | H^{#} |
|---|---|---|---|---|---|---|
| NBR polymer (blend 3330/3380) | 100 | 100 | 100 | 100 | 100 | 100 |
| Carbon black (50:50 blend N330/N550) | 55 | 55 | 55 | 55 | 55 | 55 |
| Plasticer DOTP | 32 | 32 | 32 | 32 | 32 | 32 |
| Stearic Acid | 1 | 1 | 1 | 1 | 1 | 1 |
| Antidegradant 1010 | 0.5 | 0.5 | 0.5 | 0.5 | 0.5 | 0.5 |
| Tackifying Resin | 5 | 5 | 5 | 5 | 5 | 5 |
| Cure System | | | | | | |
| Active Zinc Oxide (40 m2) | 2.5 | 2.5 | 0 | 0 | 2.5 | 0 |
| CBS 100% | 2.6 | 2.6 | 2.6 | 2.6 | 2.6 | 2.6 |
| MBT 80% | 0.2 | 0.2 | 0.2 | 0.2 | 0 | 0 |
| TBzTD 80% | 1.7 | 1.7 | 1.7 | 1.7 | 1.7 | 1.7 |
| Sulphur 80% | 0.8 | 2.8 | 0.8 | 2.8 | 0.8 | 2 |
| PxActiv8 ™ | 0 | 0 | 2 | 2 | 0 | 2 |
| Ca borate | 0 | 0 | 1 | 1 | 0 | 1 |
| ATH | 0 | 0 | 5 | 5 | 0 | 5 |

^{#}amounts in pphr

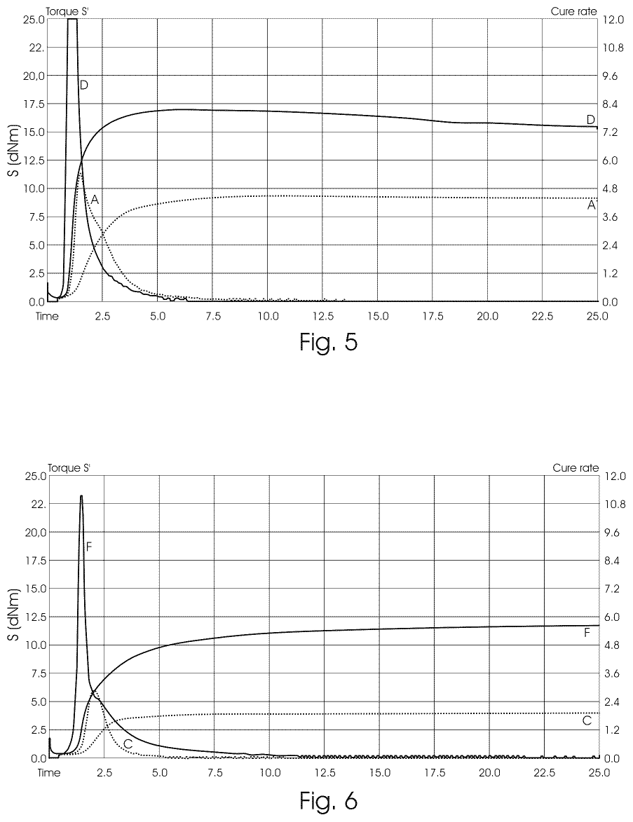

In the vulcanization packages shown in Table 6 above, samples A and D each include active ZnO at 2.5 pphr, with sample D including 2 pphr additional sulphur. Samples C and F represent ZnO free experiments with 0.8 and 2.8 pphr sulphur respectively. Samples G and H represents a comparison between ZnO and ZnO free experiments, now also excluding MBT, with sample H containing sulphur at 2 pphr. The results of these experiments are shown in FIGS. 5 to 7.

FIG. 5 shows a comparison of the curing characteristics (total cure and cure rate) of experiments A and D, including ZnO and varying levels of sulphur. As can be seen from FIG. 5, the 2.8 pphr sulphur ZnO system reverts more and is always a reverting system.

FIG. 6 shows a comparison of the curing characteristics of experiments C and F, which are ZnO free vulcanization reactions with varying levels of sulphur. As can be seen from FIG. 6, the ZnO free system requires more sulphur (as can be expected from the chemical precursor species formed) but does not seem to exhibit much reversion even when more sulphur is added.

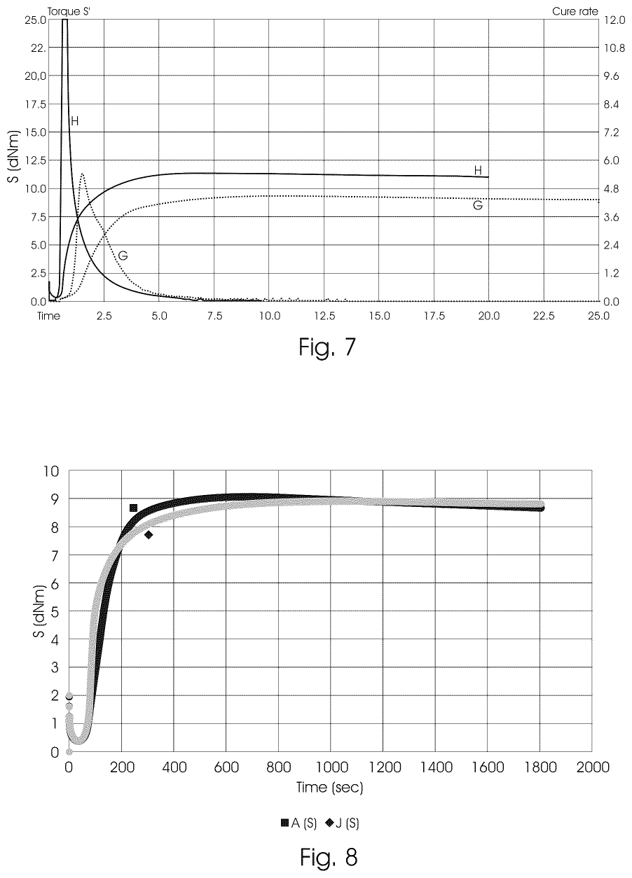

Reversion matching experiments were performed with samples G and H, the results of which are shown in FIG. 7. As can be seen from FIG. 7, at a 2 pphr loading of sulphur, the ZnO free system is reversion matched with the ZnO containing system.

In further optimization and reversion matching experiments a ZnO containing control (A) tested against a ZnO free calcium borate, ATH, PxActiv8™ system adjusted to 1.5 pphr ATH. Full formulations are provided in Table 7 below. The results of these experiments are shown in FIGS. 8 to 10.

TABLE 7
Masterbatch and cure system formulary - further
ZnO and ZnO free reversion matching reactions.

| NBR masterbatch | A^{#} | J^{#} |
|---|---|---|
| NBR polymer (blend 3330/3380) | 100 | 100 |
| Carbon black (50:50 blend N330/N550) | 55 | 55 |
| Plasticer DOTP | 32 | 32 |
| Stearic Acid | 1 | 1 |
| Antidegradant 1010 | 0.5 | 0.5 |
| Tackifying Resin | 5 | 5 |
| Cure System | | |
| Active Zinc Oxide (40 m2) | 2.5 | 0 |
| CBS 100% | 2.6 | 2.6 |
| MBT 80% | 0.2 | 0 |
| TBzTD 80% | 1.7 | 1.7 |
| Sulphur 80% | 0.8 | 2 |
| PxActiv8 ™ | 0 | 2 |
| Ca borate | 0 | 1 |
| ATH | 0 | 1.5 |

^{#}amounts in pphr

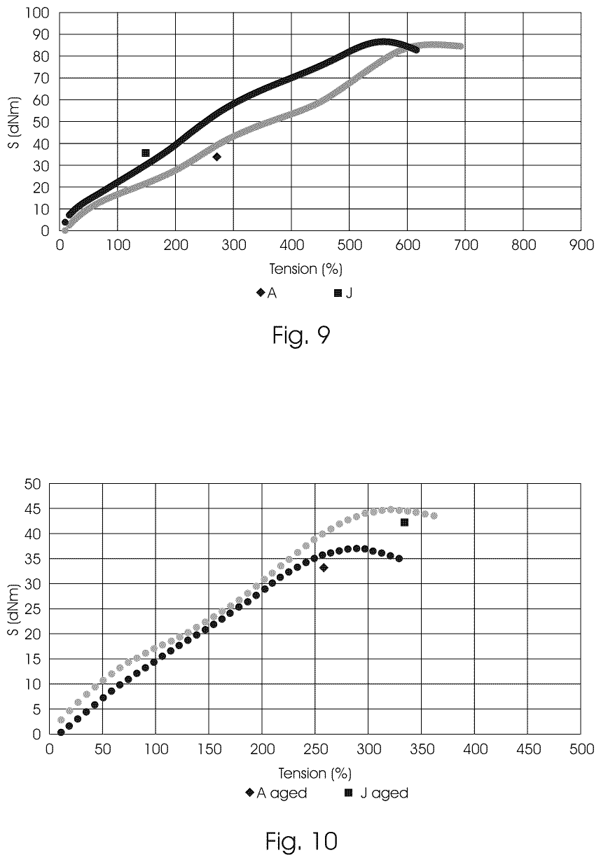

FIG. 8 clearly indicates the matching curing performance and the lack of reversion. FIG. 9 shows property comparisons for the ZnO free material compared to the vulcanizate including ZnO, indicating that the ZnO free vulcanizate is slightly higher in modulus and ultimate tensile strength. FIG. 10 indicates clearly that the ZnO free vulcanizate retains more properties after thermal accelerated aging for 168 hours at 60° C. indicating improved longevity compared to the ZnO based vulcanizate.

This above description of some of the illustrative embodiments of the invention is to indicate how the invention can be made and carried out. Those of ordinary skill in the art will know that various details may be modified thereby arriving at further embodiments, but that many of these embodiments will remain within the scope of the invention.

1. A rubber vulcanization composition suitable for use in a sulphur based vulcanization process, the composition comprising:
a) a water soluble polymer, a cationic silicate component, and a cationic additive component,
b) a borate compound, and
c) a hydroxyl containing aluminium compound.

2. The rubber vulcanization composition according to claim 1, wherein the hydroxyl containing aluminium compound is aluminium trihydrate.

3. The rubber vulcanization composition according to claim 1, wherein the composition does not include an inorganic oxide including zinc oxide.

4. The rubber vulcanization composition according to claim 1, wherein the borate compound is a salt of a boron oxyanion selected from the group consisting of orthoborates, metaborates, and tetraborates.

5. The rubber vulcanization composition according to claim 1, wherein the borate compound is selected from the group consisting of calcium borate, zinc borate, magnesium borate, sodium borate, and potassium borate.

6. The rubber vulcanization composition according to claim 1, wherein the cationic additive component is a salt of a vulcanization accelerator.

7.-9. (canceled)

10. The rubber vulcanization according to claim 6, wherein the salt of the vulcanization accelerator is a sodium or potassium salt thereof.

11. The rubber vulcanization composition according to claim 1, wherein the cation of the cationic silicate component is a sodium or potassium cation.

12. The rubber vulcanization composition according to claim 1, wherein the water soluble polymer is an ethylene oxide polymer or polyvinyl alcohol polymer.

13. The rubber vulcanization composition according to claim 12, wherein the water soluble polymer is polyethylene glycol.

14. (canceled)

15. The rubber vulcanization composition according to claim 1, wherein the water soluble polymer, cationic silicate component, and cationic additive component forms an ionic liquid composition.

16. (canceled)

17. The rubber vulcanization composition according to claim 15, wherein the borate compound and the hydroxyl containing aluminium compound is dissolved in the ionic liquid.

18. A method for the sulphur based vulcanization of a rubber masterbatch, the method comprising the steps of:
a) providing a rubber masterbatch to be vulcanized, and
b) mixing the rubber masterbatch with a vulcanization composition comprising a water soluble polymer, a cationic silicate component, a cationic additive component, a borate compound, and a hydroxyl containing aluminium compound to prepare a rubber containing reaction mixture.

19. The method according to claim 18, wherein sulphur is provided in the rubber masterbatch, premixed into the vulcanization composition of step (b), or provided separately in an additional processing step.

20. The method according to claim 18, wherein the rate of cure is controlled by the addition of a metal oxide having the same metal species as the borate compound.

21. The method according to claim 18, wherein the hydroxyl containing aluminium compound is aluminium trihydrate.

22. The method according to claim 18, wherein the method does not include the use of an inorganic oxide including zinc oxide.

23. The method according to claim 18, wherein the borate compound is a salt of a boron oxyanion selected from the group consisting of orthoborates, metaborates, and tetraborates.

24.-30. (canceled)

31. The method composition according to claim 18, wherein the water soluble polymer is an ethylene oxide polymer or polyvinyl alcohol polymer.

32.-33. (canceled)

34. The method according to claim 18, wherein the water soluble polymer, cationic silicate component, and cationic additive component forms an ionic liquid composition.

35. The method according to claim 34, wherein the ionic liquid composition comprises polyethylene glycol, sodium metasilicate and accelerator salt NaBEC.

36. The method according to claim 34, wherein the borate compound and the hydroxyl containing aluminium compound is dissolved in the ionic liquid.

37. A rubber product produced by the method of claim 18.

38. The rubber product according to claim 37, wherein the rubber does not include any zinc or source of zinc.
